(19) United States
(12) Patent Application Publication
(10) Pub. No.: US 2013/0069954 A1
(43) Pub. Date: Mar. 21, 2013

(54) Method of Transforming Time-Based Drawings and Apparatus for Performing the Same

(71) Applicant: David Tristram, San Jose, CA (US)

(72) Inventor: David Tristram, San Jose, CA (US)

(21) Appl. No.: 12/475,125

(22) Filed: May 29, 2009

(51) Int. Cl. G06T 15/70

(52) U.S. Cl. 345/473

(57) ABSTRACT

A method performed by data processing apparatus, the method including: rendering a first object on a display, the first object having first location coordinates and first temporal coordinates, in which the first location coordinates define a first drawing and each first location coordinate is associated with a respective temporal coordinate; receiving input defining a second object, the second object having second location coordinates and second temporal coordinates, in which the second location coordinates define a second drawing and each second location coordinate is associated with a respective second temporal coordinate; applying a transformation to the first location coordinate(s) responsive to receiving each second location coordinate, based on a most recently received second location coordinate and generating an animation by rendering the transformed first location coordinate(s) on the display according to the respective first temporal coordinates.

### BACKGROUND

In general, computer-based drawing applications enable a user to generate structures, graphics or illustrations as static objects which then are output to a display. In some cases, those structures, graphics or illustrations can be animated by generating copies of the original objects, applying geometric transformations (such as translating, rotating and scaling, among others) to the copied objects, and displaying the transformed objects sequentially in time.

### SUMMARY

This specification describes technologies relating to transforming time-based drawings. In general, one aspect of the subject matter described in this specification can be embodied in a method performed by a data processing apparatus, in which the method includes rendering a first object on a display, the first object having first location coordinates and first temporal coordinates, in which the first location coordinates define a first drawing and each first location coordinate is associated with a respective temporal coordinate, receiving input defining a second object, the second object having second location coordinates and second temporal coordinates, in which the second location coordinates define a second drawing and each second location coordinate is associated with a respective second temporal coordinate; applying a transformation to one or more of the first location coordinates responsive to receiving each second location coordinate, in which the transformation is based on a most recently received second location coordinate, and generating an animation by rendering the one or more transformed first location coordinates on the display according to the respective first temporal coordinates. Other embodiments of this aspect include corresponding computing platforms and computer program products.

These and other embodiments can optionally include one or more of the following features. In some embodiments, the transformation is applied to each of the one or more first location coordinates based on the most recently received second location coordinate. The animation can be generated after each transformation is applied.

In some embodiments, the transformation is applied to the one or more first location coordinates based on whether a second temporal coordinate associated with the most recently received second location coordinate corresponds to a first temporal coordinate associated with the one or more first location coordinates. The transformation can be applied to the one or more first location coordinates based on whether the second temporal coordinate associated with the most recently received second location coordinate equals the first temporal coordinate associated with the one or more first location coordinates.

In some embodiments, the transformation includes a vector translation of the one or more first location coordinates. In some implementations, the method can further include receiving an input defining an animation period in which the animation is periodically generated based on the animation period.

Particular embodiments of the subject matter described in this specification can be implemented so as to realize one or more of the following advantages. For example, the application allows, in some cases, a user to simultaneously interact with an animation as it is displayed without a visual abstraction, such as a timeline, scripting window or user interface icon, interfering with or visible during the animation. Accordingly, a user can visually observe instantaneous feedback as the appearance of an animated object is altered. In some implementations, the application enables a user to generate animations that are tied to rhythmic relationships in a corresponding musical soundtrack.

The details of one or more embodiments of the subject matter described in this specification are set forth in the accompanying drawings and the description below. Other features, aspects, and advantages of the implementations will become apparent from the description, the drawings, and the claims.

### BRIEF DESCRIPTION OF THE DRAWINGS

FIG. 1 illustrates an example of a user interacting with a time-based drawing application.

FIG. 2 illustrates an example of a system programmed to allow a user to perform transformations of time-based drawings.

FIG. 3 shows an example of a process applied by a time-based drawing application.

FIGS. 4A-4B illustrate examples of time-based drawings.

FIGS. 4C-5B illustrate examples of modifying time-based drawings.

FIG. 5C illustrates examples of time-based drawings.

FIGS. 5D-6D illustrate examples of modifying time-based drawings.

### DETAILED DESCRIPTION

In general, computer-generated animations are produced by applying the geometric transformations off-line, i.e., the intended client or audience does not observe the production of the animated feature. Nor does the act of producing of the animation typically correspond to the finalized end product that will be viewed by an audience.

In some implementations, a user or artist may be interested in producing a visual performance in which the temporal aspects of the objects, such as frequency, periodicity or phase, are altered as the objects are created. In addition, the user or artist may be interested in synchronizing such animations with a particular tempo, rhythm, soundtrack or music as part of the visual performance.

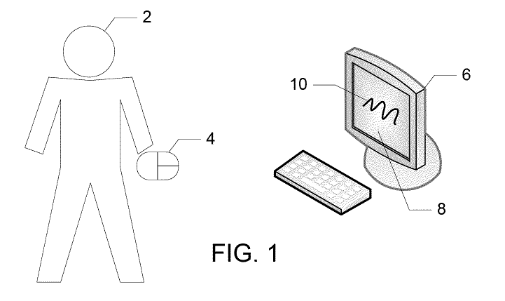

FIG. 1 shows an example of a user 2 interacting with a time-based drawing application configured to run on a computer 6. User 2 interacts with the drawing application through the aid of a user input device 4 that includes, for example, a computer mouse, keyboard, trackball, stylus or other pointing device. Employing user input device 4, user 2 provides input to the drawing application in order to create an object 10, such as, for example, a line, shape or other graphic, which then is rendered within a drawing space 8 on a display 9 of computer 6 as shown in FIG. 1.

As object 10 is output to drawing space 8, the drawing application captures the image location coordinates of object 10 on drawing space 8 as well as temporal coordinates that correspond to the time at which the respective image location coordinates are captured. The rate at which the temporal and image location coordinates are captured can be synchronized with a particular tempo/rhythm established by user 2, extracted from a file, or extracted from another software application, such as a video player or audio player. In the present implementation, the captured image location coordinates and temporal coordinates of object 10 are stored in computer-readable memory as a dataset. Once the image location coordinates and corresponding temporal coordinates are stored, multiple instances of object 10 can be rendered again within drawing space 8. For example, in some cases, object 10 is rendered within drawing space 8 periodically based on a time period set by the drawing application or specified by user input to the drawing application. In some implementations, rendering object 10 includes animating object 10. That is, the image location coordinates are displayed within drawing space 8 in time according to their corresponding temporal coordinates.

The user can provide additional input to the drawing application in order to modify the appearance or animation of object 10 within drawing space 8. In some implementations, the user can employ input device 4 to modify features of object 10 based on the input device motion. For example, the time-based drawing application can transform the image location coordinates or the temporal coordinates of the first object 10 based on a position of a mouse, trackball or other input device. In some cases, the transformation can also be based, in part, on the time at which the position of the user input device was determined. In some implementations, the transformation is based on the image location coordinates or temporal coordinates of a second object drawn within drawing space 8.

The transformed first object can be re-drawn, one or more times, by the drawing application as a new object 12. In some cases, the new object 12 is re-drawn concurrently as the image location coordinates or temporal coordinates of the first object are transformed. Alternatively, or in addition, the new object 12 is re-drawn to drawing space 8 after the transformation of the image coordinates or temporal coordinates of the first object 10. User 2 can modify the new object's phase, rate, visibility or periodic attributes to provide a performance-based mechanism for creating artwork.

In the implementation of FIG. 1, object 10 is shown as a free form curved line. Object 10 is not limited to a line, however, and can include any path, shape, text, or graphic that includes image location coordinates defining a position within a drawing space and temporal coordinates respectively corresponding to the image location coordinates. In some implementations, the time-based drawing application can apply changes to images, such as jpeg, tiff, png and gif images, that are displayed in an animation. For example, such changes include re-locating the position of an image as displayed in the animation and/or increasing or decreasing the size of a displayed image. Alternatively, or in addition, such changes can include blurring, sharpening, skewing, brightening, modifying transparency, or rotating as the image is displayed in the animation. Each of the foregoing transformations can be applied in response to the dynamic motion of input device 4 as controlled by user 2. In addition, the foregoing examples are not exhaustive as other transformations may be applied as well.

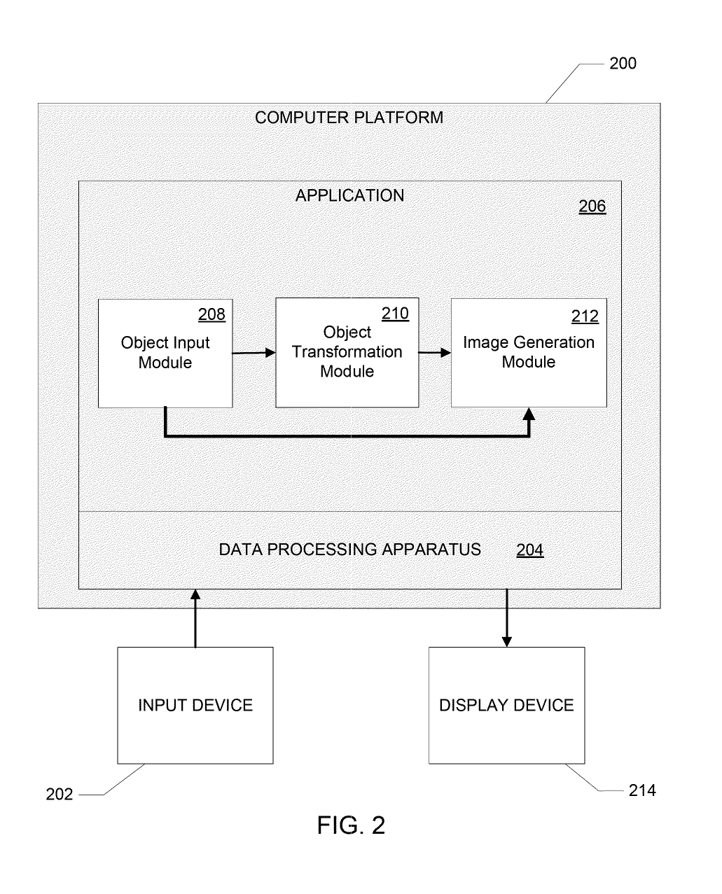

Referring to FIG. 2, an example of a system programmed to allow a user to perform transformations of time-based drawings is shown. The system can include a computer platform 200, an input device 202 and a display device 214. The computer platform 200 can include a data processing apparatus 204 and one or more programs, including a time-based drawing application 206. The time-based drawing application 206 operates, in conjunction with the data processing apparatus 204, to effect various operations described in this specification. The data processing apparatus 204 can include hardware/firmware, such as one or more processors, on which an operating system (OS) is configured to run (e.g. Windows® OS, MAC® OS, or Linux® OS), and at least one computer-readable media (e.g., random access memory or storage device). Thus, the application 206, in combination with processor(s) and computer-readable media of the data processing apparatus 204, represents one or more structural components in the system.

The time-based drawing application 206 can be an image processing application or a portion thereof. As used herein, an application refers to a computer program that the user perceives as a distinct computer tool used for a defined purpose. An application can be built entirely into the OS of the data processing apparatus 204, or an application can have different components located in different locations (e.g., one portion in the OS and one portion in a remote server connected to the platform 200), and an application can be built on a runtime library serving as a software platform of the data processing apparatus 204. The time-based drawing application 206 can include image editing software, digital publishing software, video editing software, presentation and learning software, and graphical/text editing software (e.g., Adobe® Photoshop® software, Adobe® InDesign® software, Adobe® Captivate® software, Adobe® AfterEffects® software, Adobe® Premiere®, Adobe® Flash Pro® and Adobe® Illustator® software, available from Adobe Systems Incorporated of San Jose, Calif.). The user input device(s) 202 can include, for example, keyboard(s) and a pointing device, such as a mouse, trackball, stylus, or any combination thereof. The display device(s) 214 can include a display monitor capable of producing color or gray scale pixels on a display screen. For example, the display device(s) can include a cathode ray tube (CRT) or liquid crystal display (LCD) monitor for displaying information to the user. The computer platform 200, the input device 202 and the display device 214 can together be included in a single system or device, such as a personal computer, a mobile telephone, a personal digital assistant (PDA), a mobile audio player, to name just a few.

As shown in the example of FIG. 2, the time-based drawing application 206 includes an object input module 208, an object transformation module 210, and an image generation module 212. Object input module 208 receives input, such as position information, from user input device 202 and converts the input into image location coordinates where the image location coordinates respectively correspond to a position of user input device 202. Object input module 208 also associates a temporal coordinate to each of image location coordinate, in which each temporal coordinate represents the time at which the corresponding position information was received and/or the image location coordinate was generated. The image location coordinates/temporal coordinates then can be sent to image generation module 212 or to object transformation module 210.

Based on the image location coordinates and/or temporal coordinates generated by object input module 208, Object transformation module 210 applies a transformation to the image location coordinates and/or temporal coordinates of a pre-existing object that has been rendered to a display by the time-based drawing application. The transformation can include a transformation applied to each coordinate of the pre-existing object based on a single value obtained from the object input module 208. In some cases, the transformation is applied to each coordinate of the pre-existing object based on the most recent coordinate generated by the object input module. In some implementations, the transformation is applied to the coordinates of the pre-existing object based on an image location coordinate generated by the object input module, in which the image location coordinate corresponds temporally to the coordinate of the pre-existing object.

Once the transformation has been applied, the transformed image location coordinates and/or temporal coordinates are transferred to the image generation module 212. Image generation module 212 produces an image or animation based on the transformed image location coordinates and/or temporal coordinates and outputs the image to the display device 214. Alternatively, or in addition, image generation module 212 produces an image or animation based on image location coordinates and/or temporal coordinates provided by object input module 208.

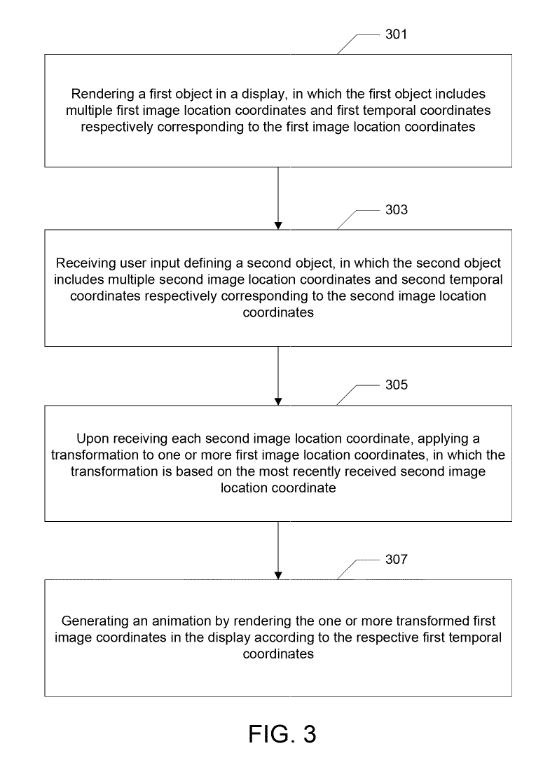

FIG. 3 shows an example of the process applied by the time-based drawing application 206. Image generation module 212 renders (301) a first object in a display, in which the first object includes multiple first image location coordinates and first temporal coordinates respectively corresponding to the first image location coordinates. The first image location coordinates and temporal coordinates can be provided by the object input module 208 or obtained from memory in computer platform 200. The style, color, and visibility of object 10 depend on the object properties available within the time-based drawing application as selected by the user. The user may select the image display properties from a legend made visible on the display by the time-based application or through the use of commands entered from input device 202.

The object input module 208 then receives (303) user input defining a second object, in which the second object includes multiple second image location coordinates and second temporal coordinates respectively corresponding to the second image location coordinates. The second image location coordinates and the second temporal coordinates then are provided to the object transformation module 210. Upon receiving each second image location coordinate, the object transformation module 210 applies a transformation to one or more of the first image location coordinates, based on the most recently received second image location coordinate.

The transformed image location coordinate(s) is then transferred to the image generation module 212 which generates (305) an animation by rendering the one or more transformed first image coordinates on the display according to the respective first temporal coordinates. The type of transformation applied to the image location coordinates can be determined by the user or applied automatically by the drawing application.

The animations produced by time-based drawing application 106 also can be rendered in a repeated (i.e., periodic) manner. For the purposes of this disclosure, the period of repetition will be referred to as a measure. The measure can be specified by the user. For example, the user can enter the period as a numeric value measured in micro-seconds, milliseconds, seconds or minutes. Other units of time-based measurement may be used as well. In some cases, the period can be extracted by the time-based drawing application 106 from a separate file or another software application. For example, in some cases, the application 206 defines a measure by analyzing an associated audio file to determine the length of the measure at a specified tempo. Drawing space 8, on which objects are formed, can be a blank image space produced on display 9 by time-based drawing application 206. A user can select various drawing tools, such as a line tool, brush tool, or shape tool, among others to draw objects in drawing space 8.

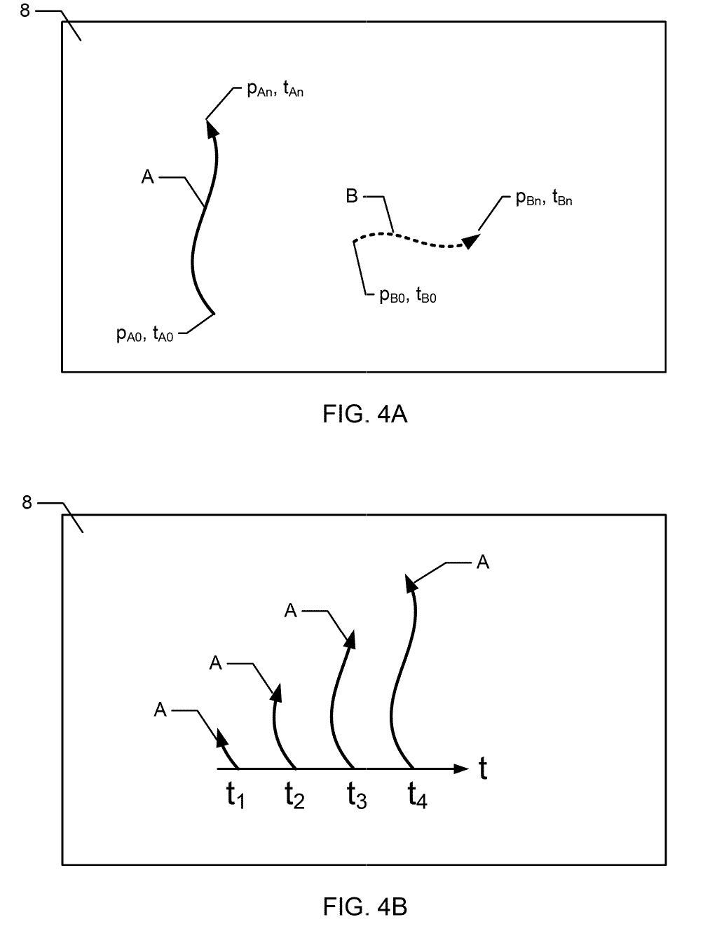

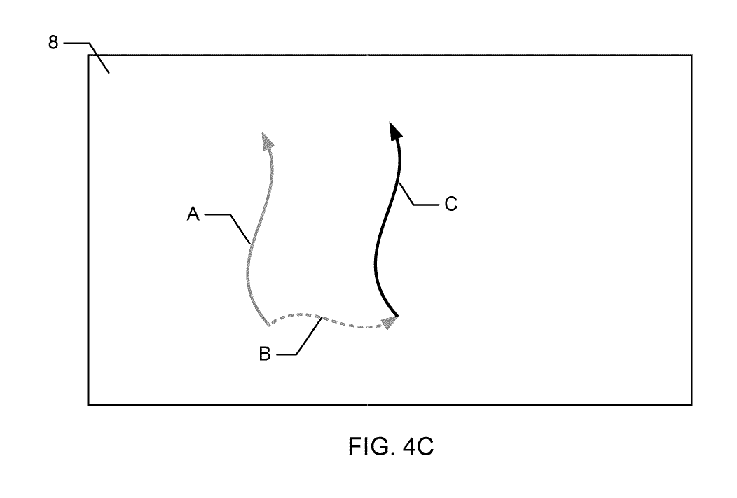

FIG. 4A illustrates an example of time-based drawings rendered on drawing space 8, including object A and object B. In the present implementation, objects A and B are shown as drawing strokes. Objects A and B are not limited to the strokes shown in FIG. 4A and can include other paths, shapes, text, or graphics. As shown in the example, stroke A is composed of a set of coordinates p, in which each of the coordinates represent a geometric position of stroke A on drawing space 8. For example, p could be representative of stroke A in Cartesian coordinates. That is, p_{A0}=(x_{A0}, y_{A0}), p₁=(x_{A1}, y_{A1}) . . . p_{An}=(x_{An}, y_{An}), where x_{An} and y_{An} respectively correspond to points along orthogonal axes of a plane. Alternatively, p can correspond to geometric coordinates of stroke A in another coordinate system such as a spherical, cylindrical or polar coordinate system. The total number of coordinates p which are representative of stroke A is determined by the final size of stroke A drawn by the user, as well as by the rate at which the drawing application captures each coordinate p. In addition to capturing the geometric position of stroke A as it is drawn, the drawing application also captures the time t at which each coordinate p is captured. That is, the initial position p_{A0} of stroke A is captured at t_{A}=t_{A0}, the next position p_{A1} is captured at t_{A}=t_{A1}, and so forth until the final position p_{An} is captured at t_{A}=t_{An}. Both the geometric coordinates p and the temporal coordinates t of stroke A then can be stored as a dataset in memory of computer 6.

Stroke A can be rendered in the drawing application as a static object in which the image location coordinates are displayed concurrently at one time within drawing space 8. Alternatively, or in addition, stroke A can be rendered as a static object repeatedly within drawing space 8. For example, in some cases, the entirety of stroke A is rendered periodically based on a specified period of time.

In some implementations, a single instance of stroke A can be animated within drawing space 8 or, alternatively, multiple instances of stroke A can be animated within drawing space 8. In some cases, the animations occur within a single period. The length of animation depends on the temporal coordinates associated with stroke A. For example, the animation of stroke A can occur over a length of time that is less than one period, equal to one period, or greater than one period. The user 2 can initiate, through the input device 202, the periodic rendering of stroke A or, alternatively, the repeated and/or periodic rendering of stroke A is applied automatically by the drawing application.

In some implementations, stroke A is animated such that each image location coordinate of stroke A is rendered to drawing space 8 over time based on a corresponding temporal coordinate so that stroke A appears as if it is being drawn on the display. For example, FIG. 4B illustrates the time evolution of image location coordinates of an initial stroke A that are being rendered based on corresponding temporal coordinates. Stroke A is shown at four separate instances of time (t₁, t₂, t₃ and t₄) in the example. The total number of rendered image location coordinates increases over the time period from t₁ to t₄. Thus, at t=t₄, stroke A is longer than at t=t₁ due to the greater total number of transformed coordinates that are rendered within drawing display 8 at t=t₄. Other implementations also are possible. For example, in some cases, the total number of rendered image location coordinates can decrease over time such that the rendered stroke appears to be disappearing. The animated appearance or disappearance of the object can be repeated periodically.

After stroke A is rendered, user 2 can employ input device 202 to draw a second stroke B, represented by the dashed line in FIG. 4A. Similar to stroke A, stroke B is composed of a set of coordinates p_{B}, in which each coordinate represents a geometric position of stroke B. The coordinates p_{B} can be, for example, part of a Cartesian, spherical, cylindrical or polar coordinate system. The total number of coordinates p_{B} which are representative of stroke B is determined by the final size of object B drawn by the user, as well as by the rate at which the drawing application captures each coordinate p_{B}. Stroke B also includes temporal coordinates t_{B} respectively associated with the image location coordinates in which the temporal coordinates represent the time at which each image location coordinate p_{B} is captured. As with stroke A, the geometric coordinates and the temporal coordinates of stroke B can be stored as a dataset in memory of computer 6. In contrast with stroke A, however, it is not necessary for the time-based drawing application to render stroke B on drawing space 8. Rather, the time-based drawing application can record the image location coordinates and the corresponding temporal coordinates of stroke B without displaying the image location coordinates of stroke B on drawing space 8.

In some implementations, stroke B is used to modify the appearance of stroke A. For example, FIG. 4C illustrates second stroke B modifying the appearance of first stroke A by applying a single value globally to the coordinates of stroke A. Thus, a new stroke C is generated by translating coordinates associated with stroke A from a first position to a second position. In the implementation shown in FIG. 4C, each of the image location coordinates of stroke A are modified by the last image location coordinate p_{Bn} of stroke B. The position of new stroke C is determined based on the value of image location coordinate p_{Bn}, i.e., the modification of stroke A includes a vector translation of each image location coordinate p_{A} based on image location coordinate p_{Bn}. Thus, although FIG. 4C shows the base of stroke B aligned with the base of stroke A, new stroke C will be rendered based on the vector length of stroke B regardless of where stroke B is drawn in drawing space 8.

In some implementations, the time-based drawing application renders objects periodically within drawing space 8. For example, if an animation period is set equal to a time t=M1, where M1 represents the length of a measure, stroke A may be rendered in drawing space 8 at the beginning of every period, i.e., t=M1, M1+length(M1), M1+2*length(M1) and so forth. Accordingly, if modifying stroke B is applied to stroke A, the application may render new stroke C at the beginning of the each period, such that both strokes A and C are visible within drawing space 8.

In some cases, portions of strokes A and/or C may disappear from drawing space 8 over time. For example, if either stroke A or C is rendered to drawing space in the first half of a period, the strokes may begin to disappear in the second half of the period. Alternatively, if either stroke A or C is rendered to drawing space over a length of time equal to one period, then the strokes may begin to disappear at the start of the second period. The disappearance of the objects in drawing space 8 can occur according to the temporal coordinates. For example, the objects can begin to disappear starting with the image location coordinates associated with the earliest temporal coordinate. Other implementations for removing objects from drawing space 8 can be employed as well.

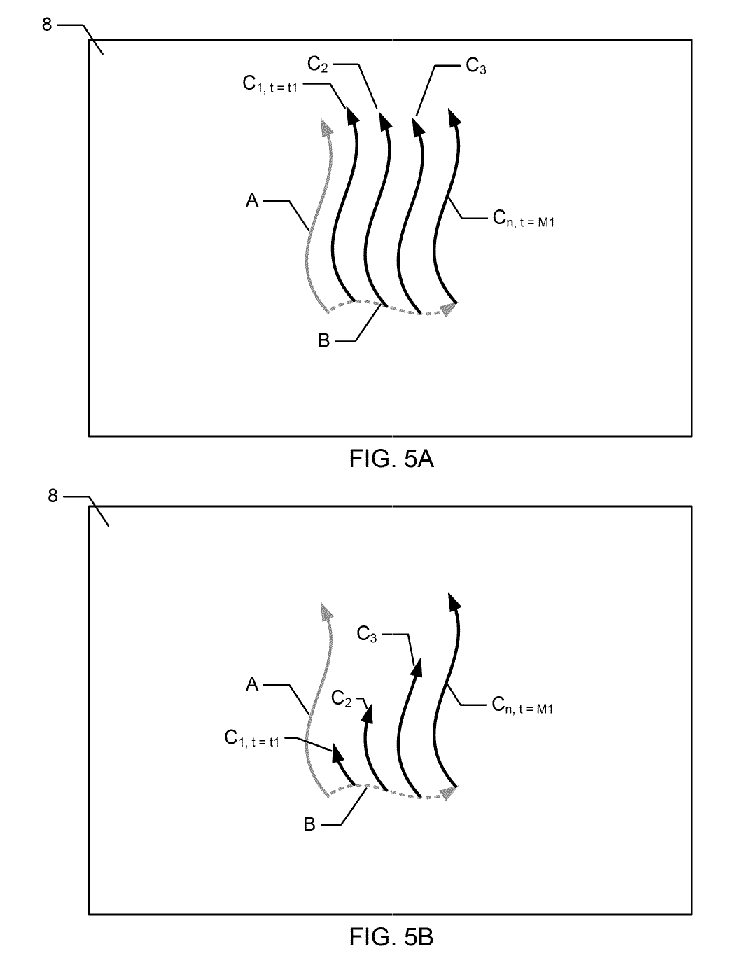

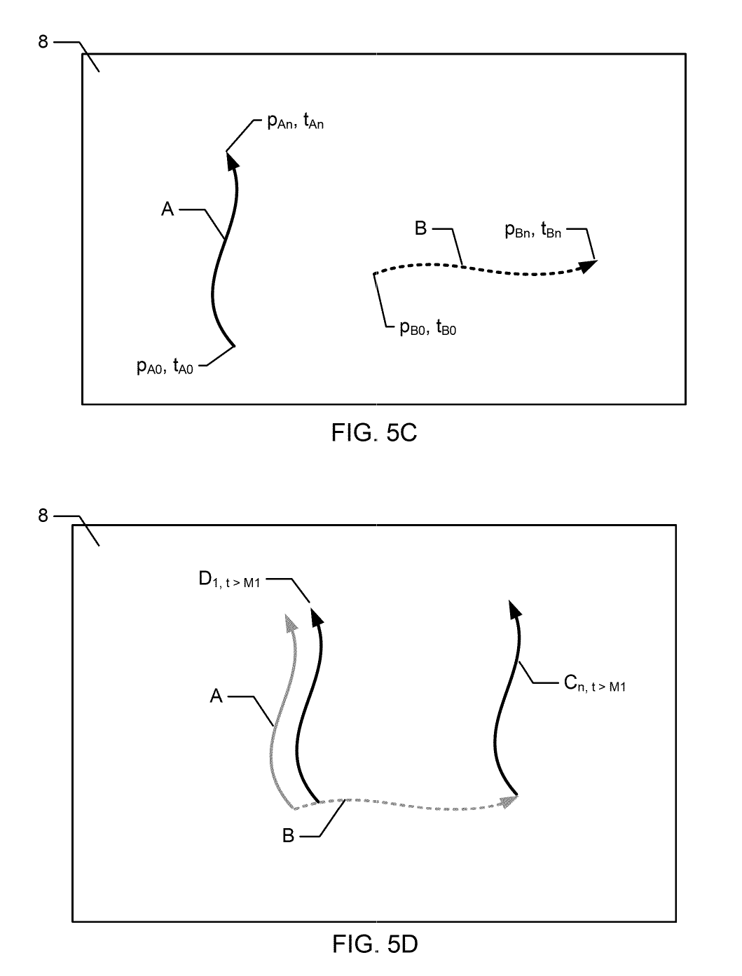

In some implementations, a series of values from the modifying object can be applied globally to a previously rendered object. For example, FIG. 5A illustrates continuously transforming each coordinate of an initial object A based on a temporally active value of a modifying object B. Initial object A and modifying object B are represented as drawing strokes, although other objects may be used as well. In the present implementation, stroke A is initially rendered within drawing space 8. A user then employs user input device 202 to generate a second stroke B which may or may not be rendered within drawing space 8. As the image location coordinates of stroke B are captured by object input module 208, the temporally active image location coordinate of stroke B, i.e., the most recently received image location coordinate, is used to globally modify the image location coordinates of stroke A. Thus, as shown in the example of FIG. 5A, multiple instances of transformed strokes C are rendered within drawing space 8 as stroke B is drawn. The first stroke C₁ is generated by modifying each image location coordinate of stroke A by the image location coordinate of stroke B that is associated with temporal coordinate t₁. Similarly, strokes C₂ and C₃ are generated by modifying each image location coordinate of stroke A by the image location coordinates of stroke B, which are respectively associated with temporal coordinates t₂ and t₃. Given that the last image location coordinate of stroke B occurs at a time equal to one period (i.e., one measure M1), new stroke Cₙ is rendered at t=M1 by transforming each of the image location coordinates by a value associated with image location coordinate Bₙ at t=M1.

As shown in FIG. 5A, each stroke C₁ through Cₙ is rendered in its entirety in drawing space 8 at the same time that a corresponding image location coordinate of stroke B is received. In some implementations, fractions of the transformed strokes are rendered at the same time that a corresponding image location coordinate of stroke B is received. For example, FIG. 5B illustrates continuously transforming each coordinate of an initial stroke A based on a temporally active value of a modifying stroke B. As shown in the example, the total number of rendered image location coordinates increases with each subsequent transformed stroke. Thus, stroke C₁ is shorter than stroke Cₙ due to the fewer number of transformed coordinates that are rendered within drawing display 8. Other implementations also are possible. For example, the total number of rendered image location coordinates can decrease with each subsequent transformed stroke such that the rendered strokes appear to be decreasing in size as a user draws modifying stroke B. In some implementations, the pattern shown in FIG. 5B is repeated during each subsequent measure.

In some implementations, the modifying stroke is drawn over a length of time that is greater than one period as defined by the time-based drawing application. For example, FIG. 5C illustrates an initial stroke A rendered in drawing space 8 and a modifying stroke B, which may or may not be rendered in drawing space 8. Stroke A includes position coordinates p_{A} and corresponding temporal coordinates t_{A}. Stroke B includes position coordinates p_{B} and corresponding temporal coordinates t_{B} in which stroke B is drawn over a time period greater than one measure M1.

FIG. 5D illustrates continuously transforming each coordinate of object A based on a temporally active value of the modifying object B shown in FIG. 5C. Similar to the implementation shown in FIG. 5A, one or more new strokes C are rendered within drawing space 8 after applying the transformation. The new strokes are not rendered, however, within only a single measure. Instead, given that modifying stroke B is drawn over a period of time greater than one measure, the last stroke Cₙ is rendered within drawing space 8 during the second measure, at a point in time M2>t>M1, where M2 is the time associated with the end of the second measure. In the present implementation, the pattern of strokes is periodically rendered within drawing space 8. Accordingly, the pattern will repeat at the beginning of every new measure. Thus, as shown in FIG. 5D, a second new stroke D is rendered within drawing space at the same time as last stroke Cₙ, i.e., before the user is finished drawing stroke B.

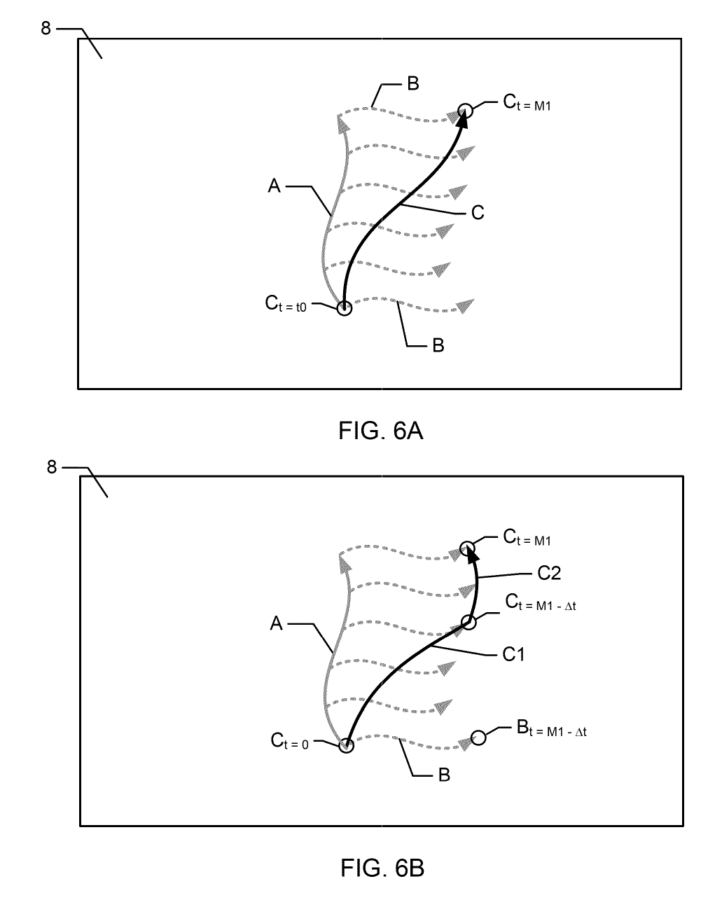

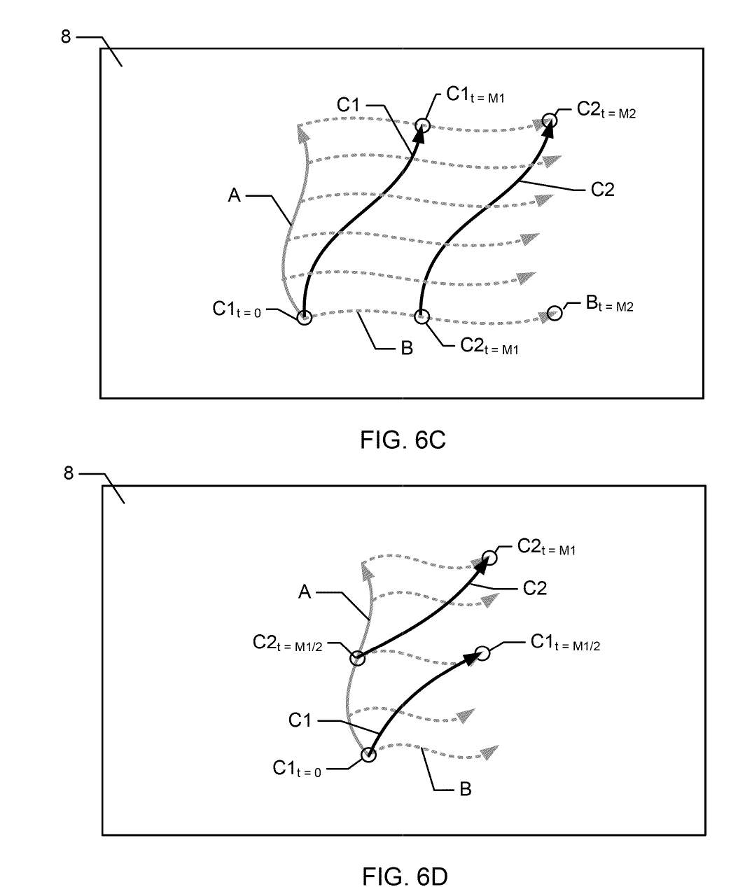

In some implementations, a single value from the modifying object can be applied incrementally to the original object. That is, each coordinate of the original object can be modified once by a value that corresponds temporally in the modifying object. FIG. 6A illustrates an example of transforming each image location coordinate of a first object A by a temporally corresponding image location coordinate of a second object B. In the present implementation, both strokes A and B have the same duration, i.e., they each extend over a time period equal to one measure. Thus, the temporal coordinates associated with the image location coordinates of stroke A may be equal to the temporal coordinates associated with the image location coordinates of stroke B. As shown in the example, the transformation results in a new stroke C in which stroke C appears as a skewed version of stroke A. Although multiple instances of stroke B are shown in FIG. 6A (and in FIGS. 6B-6D), those instances are used simply as a guide to the eye to help envision the transformation applied to the image location coordinates of stroke A and do not correspond to actual drawings of stroke B in drawing space 8.

The skewing is a result of the change in image location values of stroke B applied to stroke A as stroke B is drawn in the time-based drawing application. For example, as shown in FIG. 6A, stroke C is animated such that the first image location coordinate (Cₜ₌ₜ₀) is located at the same position as the initial coordinates of strokes A and B because the vector length of stroke B at t=t0 is zero. In contrast, the last coordinate of stroke C (at t=M1) is skewed toward the right of the last coordinate of stroke A. This is because the last image coordinate of stroke A is translated by the non-zero value associated with the temporally corresponding image location coordinate of stroke B. In some implementations, stroke C is rendered periodically such that another instance of stroke C is rendered in each subsequent measure. In some cases, the image location coordinates of a first object are not associated with temporal coordinates that correspond exactly to the temporal coordinates of a second object. In those cases, the drawing application may use approximation techniques, such as rounding, to determine the temporal correspondence between image location coordinates in a first and second object.

In some implementations, the user draws a modifying stroke B which extends over a time period that is less than one measure and which also is less than the duration of stroke A. Accordingly, one or more of the image location coordinates in the original stroke A will not be transformed by a temporally corresponding value in the modifying object. Instead, in some cases, the new stroke simply incorporates the remaining coordinates of the original stroke A without applying a transformation to those coordinates. Thus, in certain implementations, the new stroke may appear to have a discontinuity between the modified image location coordinates and the non-modified image location coordinates. Alternatively, in some cases, the one or more image location coordinates may be transformed by the last value of the modifying stroke. For example, FIG. 6B illustrates an example of transforming image location coordinates of a first stroke A by a temporally corresponding image location coordinate of a second stroke B. Stroke B extends over a time period from t=0 to t=M1−Δt, in which M1 represents the length of one measure. Given that stroke B extends over a time period that is less than the duration of stroke A and less than one full measure, only a portion of the image location coordinates in stroke A are transformed by temporally corresponding values in stroke B. The remaining image location coordinates of stroke A are rigidly translated by the last available image location coordinate of stroke B (i.e., the image location coordinate of B at t=M1−Δt. Thus, new stroke C is rendered in two parts: a first part C1, in which image location coordinates of stroke A are transformed by temporally corresponding values in stroke B; and a second part C2, in which the image location coordinates of stroke A are rigidly translated by the last image location coordinate of stroke B at t=M1−Δt. As shown in the present implementation, this results in a kink in stroke C at t=M1−Δt.

In some implementations, the modifying object extends over a time period that is longer than one full measure. In such cases, each new object that is rendered in subsequent measures may accumulate a translation based on the temporally corresponding portion of the modifying object rendered in the first measure and the temporally corresponding portion of the modifying object rendered in subsequent measures.

For example, FIG. 6C illustrates an example of transforming image location coordinates of a first stroke A by temporally corresponding image location coordinates of a second stroke B. As shown in FIG. 6C, stroke B extends over a time period that spans two measures such that the last image location coordinate of stroke B occurs at t=M2, i.e., the end of the second measure. When stroke B is initially drawn, each image location coordinate up until the coordinate located at t=M1 transforms a temporally corresponding image location coordinate of stroke A to produce new stroke C1. However, when stroke B continues being drawn during the second measure, a second new stroke C2 is rendered. C2 is produced by subsequently transforming each image location coordinate of C1 by a temporally corresponding value in stroke B. Thus, stroke C2 appears translated to the right of stroke C1. Also, stroke C2 begins to appear within drawing space 8 at t=M1, i.e., at the start of the second measure, and ends at t=M2, i.e., the start of the third measure.

In some implementations, the modifying object is drawn at a rate that is faster than the initial object is rendered in the drawing space. As in the implementation described in FIG. 6B, there may be one or more of the image location coordinates in the original object for which there is no temporally corresponding value in the modifying object. Instead of rigidly transforming those coordinates based on the last image location coordinate of the modifying object, however, the values of the modifying object can be applied a second time.

For example, FIG. 6D illustrates an example of transforming image location coordinates of a first stroke A by temporally corresponding image location coordinates of a second stroke B. As shown in the example, modifying stroke B is drawn twice as fast as the rate at which stroke A is rendered. Thus, the last image location coordinate associated with stroke B occurs at the mid-point of measure M1, i.e., t=M1/2. The image location coordinates of stroke A, on the other hand, are respectively associated with temporal coordinates over the entire measure. Thus, the last image location coordinate of stroke A is rendered at a time, t=M1. Accordingly, when stroke B is used to transform stroke A, the first half of the image location coordinates of stroke A are transformed by the image location coordinates of stroke B to produce new stroke C1. The remaining image location coordinates of stroke A are not associated with a temporally corresponding value in the modifying stroke B. Thus, the image location coordinates of modifying stroke B also are applied to the remaining image location coordinates of stroke A to produce new stroke C2. Given that the vector length of stroke B at t=0 is zero, however, the first image location coordinate of stroke C2 occurs at the same position as the image location coordinate of stroke A at t=M1/2. Furthermore, the last image location coordinate of stroke C2 is translated by the non-zero value associated with the last image location coordinate of stroke B.

Such transformations also allow a user, in some cases, to adjust the time evolution of a drawing so that it synchronizes with an associated musical soundtrack. For example, the phase of one or more modifying objects can be adjusted to synchronize the initial position of those objects with a semantically meaningful moment in the associated soundtrack, such as the downbeat of a measure. In some cases, a user can modify or refine the evolution of drawings or objects by changing their specific rate, position or appearance relative to the evolution of other objects being displayed within the application. A user can add additional objects to build up a collection of objects that are displayed and evolve in time in the application.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage medium for execution by, or to control the operation of, data processing apparatus. The computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims. For example, multiple users could interact with the application at the same time. In some cases, multiple users could collaborate to modify animations and transform time-based drawings in a shared drawing space. Each user could employ a separate input device represented in the drawing space with a particular pointer icon. Alternatively, in some cases, multiple users may interact with the drawing application in separate drawing spaces that are simultaneously visible on a display. The users could interact with the drawing application in the same location or interact remotely with the drawing application over a network from separate areas. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
rendering a first object on a display, the first object comprising a plurality of first location coordinates and a plurality of first temporal coordinates, wherein the plurality of first location coordinates define a first drawing and each first location coordinate is associated with a respective first temporal coordinate;
receiving, from a user input device, user input defining a second object, the second object comprising a plurality of second location coordinates and a plurality of second temporal coordinates, wherein the plurality of second location coordinates define a second drawing and each second location coordinate is associated with a respective second temporal coordinate;
applying a transformation to one or more of the first location coordinates responsive to receiving each second location coordinate, wherein the transformation is based on a most recently received second location coordinate; and
generating an animation by rendering the one or more transformed first location coordinates on the display according to the respective first temporal coordinates.

2. The method of claim 1 wherein the transformation is applied to each of the one or more first location coordinates based on the most recently received second location coordinate.

3. The method of claim 2 wherein the animation is generated after each transformation is applied.

4. The method of claim 1 wherein the transformation is applied to the one or more first location coordinates based on whether a second temporal coordinate associated with the most recently received second location coordinate corresponds to a first temporal coordinate associated with the one or more first location coordinates.

5. The method of claim 4 wherein the transformation is applied to the one or more first location coordinates based on whether the second temporal coordinate associated with the most recently received second location coordinate equals the first temporal coordinate associated with the one or more first location coordinates.

6. The method of claim 1 wherein the transformation comprises a vector translation of the one or more first location coordinates.

7. The method of claim 1 further comprising receiving an input defining an animation period wherein the animation is periodically generated based on the animation period.

8. A non-transitory computer storage medium encoded with a computer program, the program comprising instructions that when executed by data processing apparatus cause the data processing apparatus to perform operations comprising:
rendering a first object on a display, the first object comprising a plurality of first location coordinates and a plurality of first temporal coordinates, wherein the plurality of first location coordinates define a first drawing and each first location coordinate is associated with a respective first temporal coordinate;
receiving, from a user input device, user input defining a second object, the second object comprising a plurality of second location coordinates and a plurality of second temporal coordinates, wherein the plurality of second location coordinates define a second drawing and each second location coordinate is associated with a respective second temporal coordinate;
applying a transformation to one or more of the first location coordinates responsive to receiving each second location coordinate, wherein the transformation is based on a most recently received second location coordinate; and
generating an animation by rendering the one or more transformed first location coordinates on the display according to the respective first temporal coordinates.

9. The computer storage medium of claim 8 wherein the transformation is applied to each of the one or more first location coordinates based on the most recently received second location coordinate.

10. The computer storage medium of claim 9 wherein the animation is generated after each transformation is applied.

11. The computer storage medium of claim 8 wherein the transformation is applied to the one or more first location coordinates based on whether a second temporal coordinate associated with the most recently received second location coordinate corresponds to a first temporal coordinate associated with the one or more first location coordinates.

12. The computer storage medium of claim 11 wherein the transformation is applied to the one or more first location coordinates based on whether the second temporal coordinate associated with the most recently received second location coordinate equals the first temporal coordinate associated with the one or more first location coordinates.

13. The computer storage medium of claim 8 wherein the transformation comprises a vector translation of the one or more first location coordinates.

14. The computer storage medium of claim 8 wherein the program comprises instructions that when executed by data processing apparatus cause the data processing apparatus to perform operations further comprising receiving an input defining an animation period wherein the animation is periodically generated based on the animation period.

15. A system comprising:
a display device comprising a display;
a user input device coupled to the display device; and
one or more computers including data processing apparatus operable to interact with the display device and configured to perform operations comprising:
rendering a first object on the display, the first object comprising a plurality of first location coordinates and a plurality of first temporal coordinates, wherein the plurality of first location coordinates define a first drawing and each first location coordinate is associated with a respective first temporal coordinate;
receiving, from the user input device, user input defining a second object, the second object comprising a plurality of second location coordinates and a plurality of second temporal coordinates, wherein the plurality of second location coordinates define a second drawing and each second location coordinate is associated with a respective second temporal coordinate;
applying a transformation to one or more of the first location coordinates responsive to receiving each second location coordinate, wherein the transformation is based on a most recently received second location coordinate; and
generating an animation by rendering the one or more transformed first location coordinates on the display according to the respective first temporal coordinates.

16. The system of claim 15 wherein the transformation is applied to each of the one or more first location coordinates based on the most recently received second location coordinate.

17. The system of claim 16 wherein the animation is generated after each transformation is applied.

18. The system of claim 15 wherein the transformation is applied to the one or more first location coordinates based on whether a second temporal coordinate associated with the most recently received second location coordinate corresponds to a first temporal coordinate associated with the one or more first location coordinates.

19. The system of claim 18 wherein the transformation is applied to the one or more first location coordinates based on whether the second temporal coordinate associated with the most recently received second location coordinate equals the first temporal coordinate associated with the one or more first location coordinates.

20. The system of claim 15 wherein the transformation comprises a vector translation of the one or more first location coordinates.

21. The system of claim 15 wherein the data processing apparatus is configured to perform operations further comprising receiving an input defining an animation period wherein the animation is periodically generated based on the animation period.

22. The method of claim 1, further comprising:
receiving, from the user input device, the plurality of first location coordinates during a time period; and
determining each of the first temporal coordinates based on a time when a respective one of the first location coordinates is received during the time period.

23. The computer storage medium of claim 8, wherein the program comprises instructions that when executed by data processing apparatus cause the data processing apparatus to perform operations further comprising:
receiving, from the user input device, the plurality of first location coordinates during a time period; and
determining each of the first temporal coordinates based on a time when a respective one of the first location coordinates is received during the time period.

24. The system of claim 15 wherein the data processing apparatus is configured to perform operations further comprising:
receiving, from the user input device, the plurality of first location coordinates during a time period; and
determining each of the first temporal coordinates based on a time when a respective one of the first location coordinates is received during the time period.
